(19) United States
(12) Patent Application Publication
(10) Pub. No.: US 2008/0042501 A1
(43) Pub. Date: Feb. 21, 2008

(54) THERMAL TRANSFER CONTAINER FOR SEMICONDUCTOR COMPONENT

(76) Inventors: Robert Malanga, Lake Mary, FL (US); John P. Lasek, Port Orange, FL (US); An Huu Nguyen, Orlando, FL (US); Toan Van Mai, Orlando, FL (US); Frank C. Oropeza, Apopka, FL (US); Frank W. Oropeza, Apopka, FL (US)

Correspondence Address: RICHARD K. WARTHER;ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/877,737

(22) Filed: Oct. 24, 2007

Related U.S. Application Data
(62) Division of application No. 10/846,011, filed on May 14, 2004.
(60) Provisional application No. 60/471,662, filed on May 19, 2003.

(51) Int. Cl. H02K 11/04

(52) U.S. Cl. 310/68 D

(57) ABSTRACT

A thermal transfer container is disclosed for a semiconductor component to transfer heat to a heat sink such as used in rectifiers for alternators. The thermal transfer container includes an outer cylindrical surface having threads that engage threads defined in the heat sink bore for electrically and thermally connecting the metallic cylindrical container to the heat sink.

### RELATED APPLICATIONS

This application is based upon prior filed copending provisional application Ser. No. 60/471,662 filed May 19, 2003.

### FIELD OF THE INVENTION

This invention relates to solid state electrical devices and more particularly to an improved thermal transfer container for a semiconductor component for transferring heat to a heat sink.

### BACKGROUND OF THE INVENTION

Semiconductor components such as diodes, transistors, integrated circuits and the like generate heat during normal operation. Most semiconductor components are thermally coupled to transfer heat to a heat sink for dissipating the heat generated by the semiconductor component. Some semiconductor components are coupled through a thermal transfer container to a heat sink. The thermal transfer container transfers heat generated by the semiconductor component to the heat sink.

One specific use application for a semiconductor diode component is the use in electrical generating equipment such as electrical alternators and the like. In an electrical alternator, a rotor rotates within a stator for generating alternating current (AC) power. Many electrical alternators are used to provide direct current (DC) power to a DC power system. When (DC) power is required, semiconductor diodes are used to rectify alternating current (AC) power into direct current (DC) power.

A very popular type of AC to DC system is found in ignition systems in various types of land vehicles, aircraft, and sea vessels. These AC to DC generating systems use a plurality of diodes arranged as an alternator rectifier unit. An alternator rectifier unit comprises a plurality of diodes installed in a positive and a negative heat sink configuration that is welded into a frame to form the alternator rectifier unit.

One traditional method of manufacturing the alternator rectifier unit comprises the use of a semiconductor diode in the form of a silicone glass passivated wafer. The semiconductor diode wafer was located within a thermal transfer container commonly referred to as a diode cup.

The thermal transfer container was in the general form of a cup having been formed by a cylindrical container having a first end closed by an end wall. A first side of the semiconductor diode wafer was affixed to the end wall of the thermal transfer container. An electrical lead was connected to a second side of the semiconductor diode to extend from the open end of the cylindrical container. An epoxy material filled the cylindrical container to secure the semiconductor diode wafer within the thermal transfer container.

The thermal transfer container was provided with a series of knurls extending about the outer cylindrical surface of the thermal transfer container. The knurls enabled the thermal transfer container including the semiconductor diode to be pressed fitted into an aperture of a heat sink. The knurls of the thermal transfer container engaged with the aperture of a heat sink for electrically and thermally connecting the cylindrical container to the heat sink. Although these alternator rectifier units have found wide spread use in the art, these alternator rectifier units suffered from several disadvantages.

Semiconductor diodes in the form of a silicone glass passivated wafer are susceptible to damage during the press fit operation. Damage to only one of the semiconductor diodes results in an electrical failure of the entire alternator rectifier unit. Since most of the alternator rectifier units were welded into a unit, the failure of only one diode renders the entire alternator rectifier unit inoperative with no present method to replace a failed diode in an alternator rectifier unit.

Only the peaks of the knurls of the thermal transfer container engaged with the aperture of a heat sink for electrically and thermally connecting the cylindrical container to the heat sink. Since only the peaks of the knurls engaged with the aperture of the heat sink, only about fifty percent (50%) of the thermal transfer container actually engages the heat sink.

Accordingly, the thermal transfer containers of the prior art exhibited only adequate electrical and thermal connection of the cylindrical container to the heat sink.

Some prior art proposals have attempted to provide a solution for installing semiconductor components to a heat sink. These proposals include disclosures found in U.S. Pat. Nos. 2,790,940; 2,820,929; 3,025,435; 3,033,537; 3,176,201; 3,182,117; 3,218,524; 3,229,756; 3,480,844; 3,713,007; 3,946,416; 4,607,685; 5,313,099; 5,703,395; 5,789,813; 6,021,045; 6,455,929; and 6,476,527. None of these proposals have solved the problems identified above, especially regarding alternator rectifiers.

### SUMMARY OF THE INVENTION

Therefore, it is an object of the present invention to provide an improved thermal transfer container for a semiconductor component for transferring heat to a heat sink with enhanced electrical and thermal conductivity between the semiconductor component and the heat sink.

Another object of this invention is to provide an improved thermal transfer container for a semiconductor component that provides a consistent electrical and thermal conductivity between the semiconductor components and heat sinks in a manufacturing process.

Another object of this invention is to provide an improved thermal transfer container for a semiconductor component that may be readily removed from the heat sink for replacing a defective semiconductor component.

Another object of this invention is to provide an improved thermal transfer container for a semiconductor component that does not appreciably add to the cost of the thermal transfer container relative to the thermal transfer containers of the prior art.

The present invention relates to an improved thermal transfer container for a semiconductor component for transferring heat to a heat sink such as heat sink plates of automotive alternators. A threaded heat sink bore is defined in a heat sink. A cylindrical container has a cylindrical surface extending between a first and a second cylindrical end. A first end wall closes the first end of the cylindrical container. A first connector electrically and thermally connects a first terminal of the semiconductor component to the first end wall of the cylindrical container. A second connector affixes an electrical lead to a second terminal of the semiconductor component with the electrical lead extending from the second cylindrical end of the cylindrical container. Cylindrical threads are disposed about the cylindrical surface of the cylindrical container for threadably engaging with the threaded heat sink bore of the heat sink for electrically and thermally connecting the cylindrical container to the heat sink.

In a more specific example of the invention, the cylindrical container is a metallic container such as a metallic copper container. Preferably, the first end wall is integrally formed with the first end of the cylindrical container as a one-piece unit.

The first connector comprises a first metallic connector for directly electrically and thermally connecting the first terminal of the semiconductor component to an interior surface of the first end wall of the cylindrical container. The second connector comprises a second metallic connector for directly electrically affixing an electrical lead to the second terminal of the semiconductor component with the electrical lead extending from the second cylindrical end of the cylindrical container. In one example, the first and second metallic connectors comprise a first and second solder connectors.

In one example of the invention, the first end wall extends radially outward from the cylindrical sidewall to form a radial flange for electrically and thermally contacting the heat sink when the cylindrical threads of the cylindrical container are threadably engaged with the threaded heat sink bore of the heat sink for providing enhanced electrical and thermal conduction with the heat sink.

The cylindrical threads engaging with the threaded heat sink bore enables the cylindrical container to be unscrewed from the threaded heat sink bore to replace a cylindrical container having a defective semiconductor component. Preferably, a recess is defined in an exterior surface of the first end wall for matingly receiving a tool for rotating the cylindrical container relative to the threaded heat sink bore of the heat sink.

### BRIEF DESCRIPTION OF THE DRAWINGS

Other objects, features and advantages of the present invention will become apparent from the detailed description of the invention which follows, when considered in light of the accompanying drawings in which:

FIG. 1 is an isometric view of an alternator containing a rectifier circuit of the prior art.

FIG. 2 is an enlarged view of the rectifier circuit of FIG. 1.

FIG. 3 is an exploded view of the rectifier circuit of FIG. 2.

FIG. 4 is an isometric view of a thermal transfer container of the prior art for transferring heat from a semiconductor diode to a heat sink.

FIG. 5 is a bottom view of the thermal transfer container of FIG. 4.

FIG. 6 is a side view of FIG. 5.

FIG. 7 is a view of the thermal transfer container of FIGS. 4-6 secured to a heat sink.

FIG. 8 is an enlarged view along line 8-8 in FIG. 7.

FIG. 9 is a magnified view of FIG. 8.

FIG. 10 is an isometric view of an alternator containing a rectifier circuit of the present invention.

FIG. 11 is an enlarged view of the rectifier circuit of FIG. 10.

FIG. 12 is a partially exploded view of the rectifier circuit of FIG. 11.

FIG. 13 is a fully exploded view of the rectifier circuit of FIG. 11.

FIG. 14 is an isometric view of a thermal transfer container of the present invention for transferring heat from a semiconductor diode to a heat sink.

FIG. 15 is a bottom view of the thermal transfer container of FIG. 14.

FIG. 16 is a side view of FIG. 15.

FIG. 17 is a top view of FIG. 15.

FIG. 18 is a sectional view along line 18-18 in FIG. 15.

FIG. 19 is a view of the thermal transfer container of FIGS. 14-18 secured to a first type of heat sink.

FIG. 20 is an enlarged view along line 20-20 in FIG. 19.

FIG. 21 is a view of the thermal transfer container of FIGS. 14-18 secured to a second type of heat sink.

FIG. 22 is an enlarged view along line 22-22 in FIG. 21.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

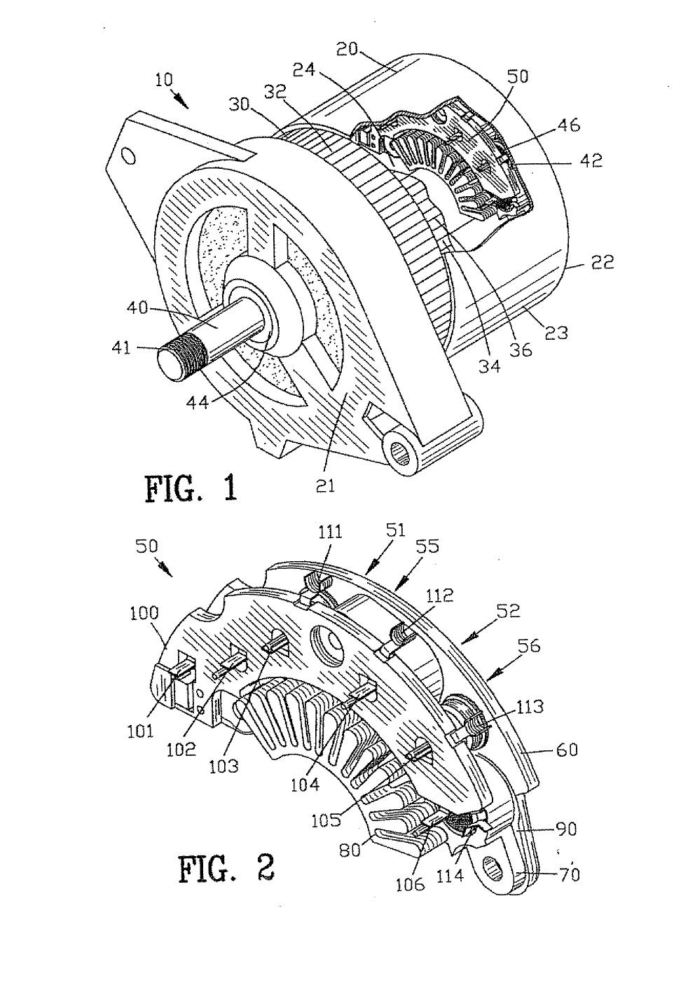

FIG. 1 is an isometric view of an alternator 10 of the prior art shown as a typical alternator for use with an engine of an automobile, boat, airplane or the like. The alternator 10 comprises a housing 20 extending from a drive end frame 21 to a slip ring end frame 22. The housing 20 comprises a substantially cylindrical outer surface 23 defining an alternator interior space 24. A stator 30 has a stator winding 32 mounted to the housing 20 within the interior space 24 thereof. Typically, the stator winding 32 comprises a plurality of stator windings wound about a stator lamination in a three-phase configuration.

A rotor 34 having a rotor winding 36 is rotatably mounted within the stator 30. The rotor 34 is mounted to a drive shaft 40 having a first and a second end 41 and 42. A first and a second bearing 44 and 46 are secured to the drive end frame 21 and the slip ring end frame 22 for journaling the drive shaft 40.

The first end 41 of the drive shaft 40 is rotated by an engine (not shown) or the like for generating electrical power. The rotation of the rotor winding 36 of the rotor 34 within the stator winding 32 of the stator 30 generates alternating current (AC) electrical power. A rectifier assembly 50 is provided for converting the alternating current (AC) electrical power into direct current (DC) electrical power.

FIG. 2 is an enlarged view of the prior art rectifier assembly 50 of FIG. 1. In this example, the rectifier assembly 50 is shown as a full wave rectifier bridge comprising a plurality of negative diodes 51 and a plurality of positive diodes 52. Each of the plurality of negative diodes 51 is mounted within a negative thermal transfer container 55. Similarly, each of the plurality of positive diodes 52 is mounted within a positive thermal transfer container 56.

The plurality of negative thermal transfer containers 55 containing the negative diodes 51 are mounted to a negative heat sink 60. Similarly, the plurality of positive thermal transfer containers 55 containing the positive diodes 52 are mounted to a positive heat sink 70. The negative heat sink 60 and the positive heat sink 70 are secured relative to one another with an insulator 90 interposed therebetween. An external terminal 100 provides a connection strip for the negative diodes 51 and the positive diodes 52.

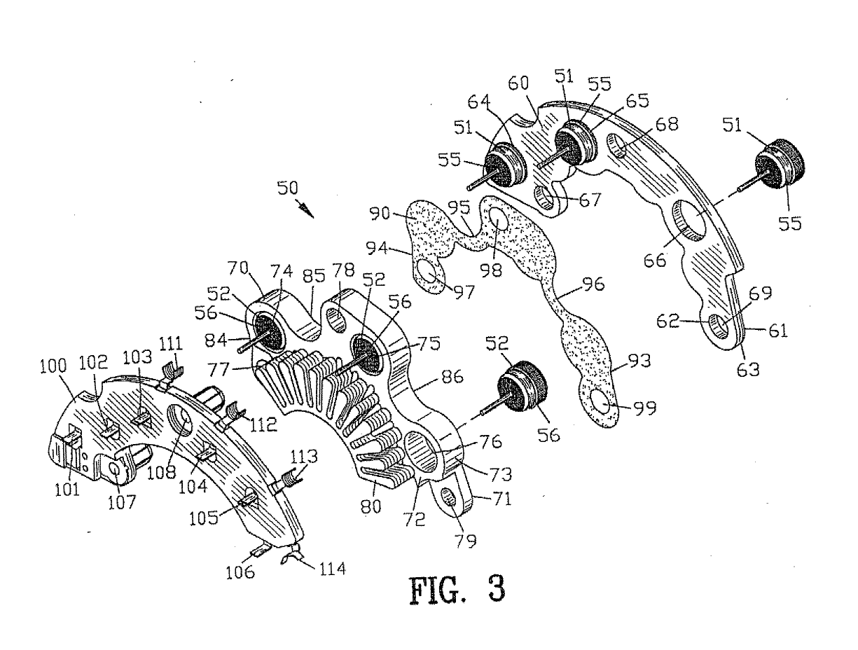

FIG. 3 is an enlarged exploded view of the prior art rectifier assembly 50 of FIG. 2. The negative heat sink 60 is shown having a generally flat configuration having a first and a second side 61 and 62 and a peripheral edge 63. The negative heat sink 60 defines a plurality of negative diode bores 64-66 extending through the negative heat sink 60. A plurality of mounting holes 67-69 extend through the first and second sides 61 and 62 for mounting the negative heat sink 60.

Each of the plurality of negative diode bores 64-66 is adapted to receive a negative thermal transfer container 55 housing the negative diode 51. As will be described in greater detail hereinafter, each of the plurality of negative diode bores 64-66 receives a negative thermal transfer container 55 in a press fit engagement.

The positive heat sink 70 is shown having a generally flat configuration having a first and a second side 71 and 72 and a peripheral edge 73. The positive heat sink 70 defines a plurality of positive diode bores 74-76 extending through the positive heat sink 70. A plurality of mounting holes 77-79 extend through the first and second sides 71 and 72 for mounting the positive heat sink 70. In this example, the plurality of mounting holes 77-79 of the positive heat sink 70 are aligned with the plurality of mounting holes 67-69 of the negative heat sink 60.

Each of the plurality of positive diode bores 74-76 is adapted to receive a positive thermal transfer container 56 housing a positive diode 52. As will be described in greater detail hereinafter, each of the plurality of positive diode bores 74-76 receives a positive thermal transfer container 56 in a press fit engagement.

The positive heat sink 70 includes a supplemental heat sink 80 secured to the second side 72 of the positive heat sink 70. The supplemental heat sink 80 adds additional mass and additional surface area to the positive heat sink 70 for cooling the plurality of positive diodes 52 housed within the plurality of positive thermal transfer containers 56.

In this example, the a peripheral edge 73 of the positive heat sink 70 is provided with notches 84-86 for accommodating for the negative thermal transfer containers 55 located in the negative diode bores 64-66 of the negative heat sink 60.

The insulator 90 defines a peripheral edge 93 having notches 94-96. The notches 94-96 are provided for accommodating for the negative thermal transfer containers 55 located in the negative diode bores 64-66 of the negative heat sink 60. A plurality of mounting holes 97-99 extending through the insulator 90 for mounting between the negative heat sink 60 and the positive heat sink 70.

The external terminal 100 includes contacts 101, 103 and 105 for connecting to the negative diodes 51 and contacts 102, 104 and 106 for connecting to the positive diodes 52. Plural mounting holes 107 and 108 are aligned with the plural mounting holes 67 and 68 of the negative heat sink 60. The contacts 101-106 are connected to external contacts 111-114.

The rectifier assembly S0 comprises a stacked assembly of the negative heat sink 60, the insulator 90, the positive heat sink 70 and the external terminal 100. The plurality of negative thermal transfer containers 55 are press fit into the plurality of negative diode bores 64-66. The plurality of positive thermal transfer containers 56 are press fit into the plurality of positive diode bores 74-76. The insulator 90 is located between the negative heat sink 60 and the positive heat sink 70. The connector 100 is positioned adjacent the second side 72 of the positive heat sink 70 as shown in FIG. 3. The stacked assembly is secured with a mechanical fastener extending through the mounting holes in the negative heat sink 60, the insulator 90, the positive heat sink 70 and the external terminal 100.

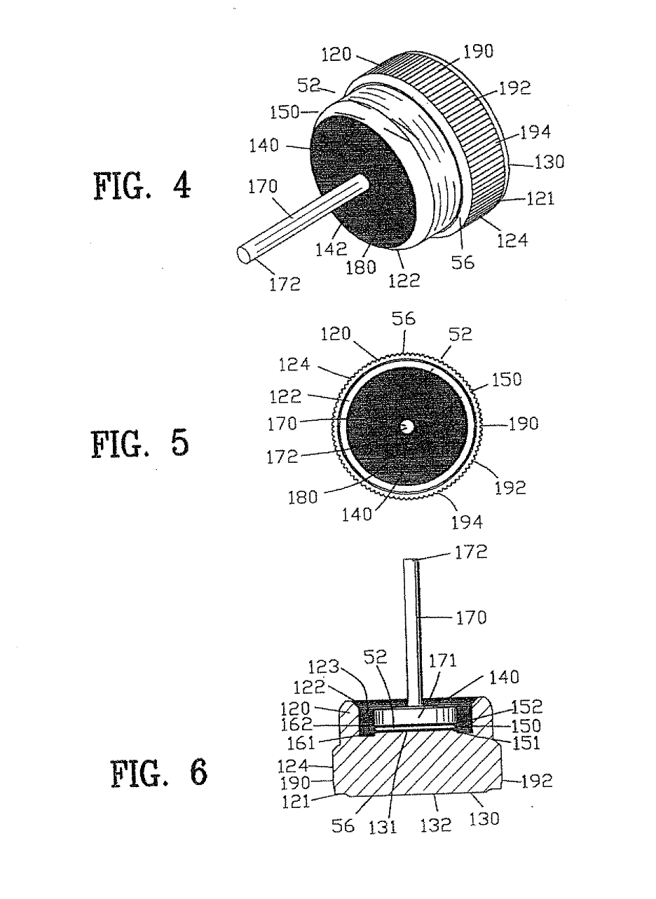

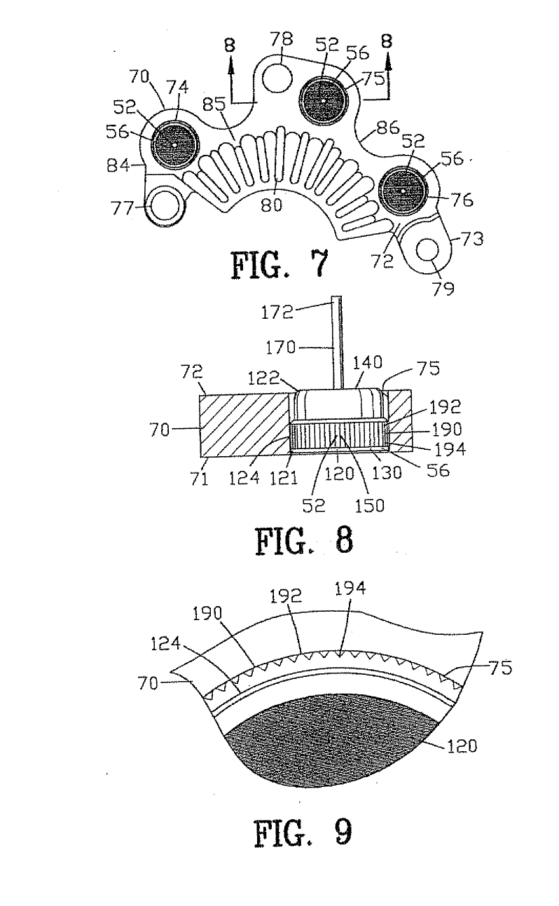

FIGS. 4-9 illustrate various views of thermal transfer container 56 of the prior art for containing the positive diode 52. Although the thermal transfer container 56 is shown associated with the positive diode 52, it should be understood that the thermal transfer container 55 for the negative diode 51 functions in a similar manner.

The thermal transfer container 56 is a generally cylindrical container 120 extending between a first and a second cylindrical end 121 and 122. The generally cylindrical container defines an inner cylindrical surface 123 and an outer cylindrical surface 124. The thermal transfer container is formed of a metallic material such as aluminum.

A first end wall 130 closes the first end of the cylindrical container. The first end wall 130 defines an inner end wall surface 131 and an outer end wall surface 132. The first end wall 130 is integrally formed with the first end 121 of the cylindrical container 120 as a one piece unit. The second end 122 of the cylindrical container 120 defines an opening 140. The generally cylindrical container 120 in combination with the first end wall 130 defines a cup shape having an inner volume 142 for containing the positive diode 52.

The positive diode 52 comprises a wafer 150 having a first and a second terminal 151 and 152. The first terminal 151 is shown as the negative terminal of the semiconductor diode whereas the second terminal 152 is shown as the positive terminal of the positive diode 52. The semiconductor diode is a glass passivated silicon diode.

A first connector 161 connects the first terminal 151 of the positive diode 52 to the inner end wall 131 surface of the first end wall 130 of the cylindrical container 120. The first connector 161 directly connects the positive diode 52 to the first end wall 130 of the cylindrical container 120. Typically, the first connector 161 comprises a first solder connector to provide a simultaneous electrical and thermal connection of the positive diode 52 to the cylindrical container 120.

A second connector 162 comprises an electrical lead 170 extending between a first and a second electrical lead end 171 and 172. The second connector 162 directly electrically affixes the first end 171 of the electrical lead 170 to the second terminal 152 of the positive diode 52. The second end 172 of the electrical lead 170 extends from the opening 140 in the second end 122 of the cylindrical container 120. Typically, the second connector 162 comprises a second solder connector to provide an electrical connection of the first end 171 of the electrical lead 170 to the positive diode 52.

The curable material 180 fills the inner volume 140 of the thermal transfer container 56 for retaining the positive diode 52 within the thermal transfer container 56. The curable material 180 is an insulating curable material 180 such as a curable epoxy material or any suitable curable material. The curable material 180 adds mechanical strength to the electrical lead 170 extending from the opening 140 in the second end 122 of the cylindrical container 120.

As best shown in FIG. 9, a knurl 190 extends about the outer cylindrical surface 124 of the cylindrical container 120. The knurl 190 includes a series of knurl projections 192 spaced about the outer cylindrical surface 124 of the cylindrical container 120. The series of voids 194 are defined between each adjacent pair of the knurl projections 192.

Each of the series of knurl projections 192 is deformable for enabling the outer cylindrical surface 124 of the cylindrical container 120 to be press fit into the positive diode bore 75. The cylindrical container 120 is formed from a conductive deformable material such as aluminum for enabling the series of knurl projections 192 to be deformed to electrically and thermally connect the cylindrical container 120 to the positive heat sink 70.

The thermal transfer container 56 of the prior art provided reasonable reliable electrical and thermal connection of the cylindrical container 120 to the positive heat sink 70. However, the thermal transfer container 56 of the prior art suffered from several inherent problems.

Variation in the outer diameter of the knurl projections 192 and/or variation in the inner diameter of the positive diode bore 75 produced unreliable electrical and thermal connection of the cylindrical container 120 with the positive heat sink 70.

When the variation in the knurl projections 192 and/or the positive diode bore 75 were within tolerance, only the peaks of the knurl projections 192 made electrical and thermal contact with the positive heat sink 70. The surface area represented by the series of voids 194 did not make electrical and thermal contact with the positive heat sink 70. This lack of electrical and thermal contact increased the electrical resistance and decreased the thermal conductivity to the positive heat sink 70.

When the variation in the knurl projections 192 and/or the positive diode bore 75 had a loose tolerance, many of the peaks of the knurl projections 192 did not make electrical and thermal contact with the positive heat sink 70. This lack of electrical and thermal contact increased the electrical resistance and decreased the thermal conductivity to the positive heat sink 70.

When the variation in the knurl projections 192 and/or the positive diode bore 75 had a tight tolerance, the process of press fitting the thermal transfer container 56 into the positive diode bore 75 deformed the cylindrical container 120. In some cases, the deformation of the cylindrical container 120 damaged the positive diode 52 within the cylindrical container 120. When the thermal transfer container 56 was pressed into the positive heat sink 70, a thermal transfer container 56 with a damaged the positive diode 52 could not be removed easily from the positive heat sink 70. Accordingly, the entire rectifier assembly 50 had to be scrapped during the manufacturing process.

When a positive diode 52 failed during operation, the press fit engagement prevent easy replacement of the failed positive diode 52 without the replacement of the entire rectifier assembly 50.

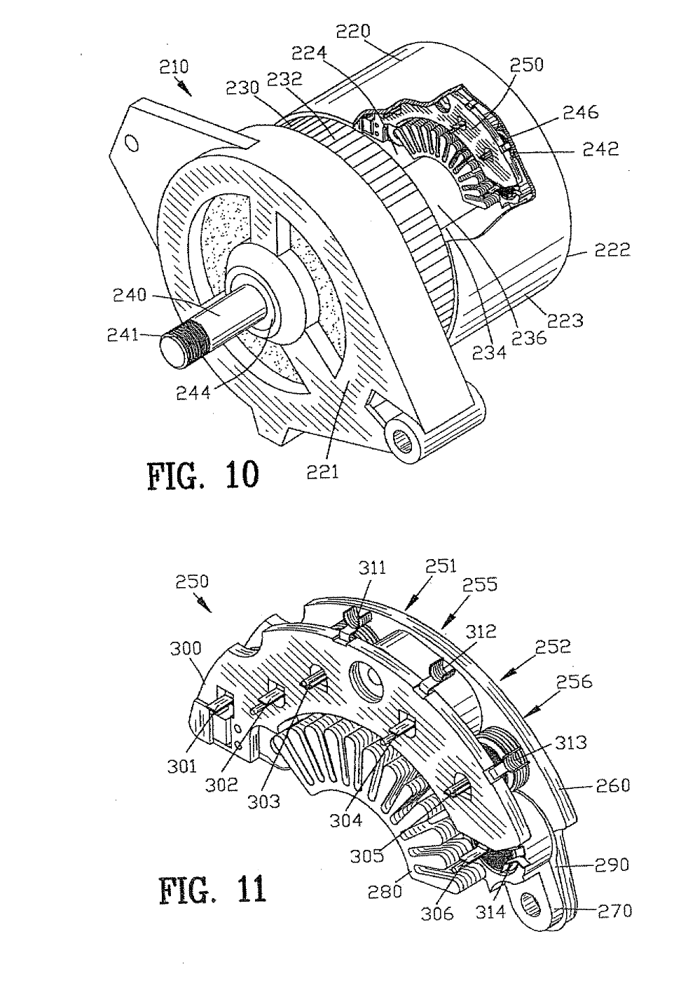

FIG. 10 is an isometric view of an alternator 210 of an alternator incorporating the present invention. The alternator 210 comprises a housing 220 extending from a drive end frame 221 to a slip ring end frame 222. The housing 220 comprises a substantially cylindrical outer surface 223 defining an alternator interior space 224. A stator 230 has a stator winding 232 mounted to the housing 220 within the interior space 24.

A rotor 234 having a rotor winding 236 is rotatably mounted within the stator 230. The rotor 234 is mounted to a drive shaft 240 having a first and a second end 241 and 242 supported by a first and a second bearing 44 and 46.

The alternator 210 of the present invention incorporates an improved rectifier assembly 250 for converting the alternating current (AC) electrical power into direct current (DC) electrical power in a more efficient and reliable manner.

FIG. 11 is an enlarged view of the improved rectifier assembly 250 of FIG. 10, comprising a plurality of negative diodes 251 and a plurality of positive diodes 252. Each of the plurality of negative diodes 251 is mounted within a negative thermal transfer container 255. Similarly, each of the plurality of positive diodes 252 is mounted within a positive thermal transfer container 256.

The plurality of negative thermal transfer containers 255 containing the negative diodes 251 are mounted to a negative heat sink 260. The plurality of positive thermal transfer containers 256 containing the positive diodes 252 are mounted to a positive heat sink 270. The negative heat sink 260 and the positive heat sink 270 are secured relative to one another with an insulator 290 interposed therebetween. An external terminal 300 provides a connection strip for the negative diodes 251 and the positive diodes 252.

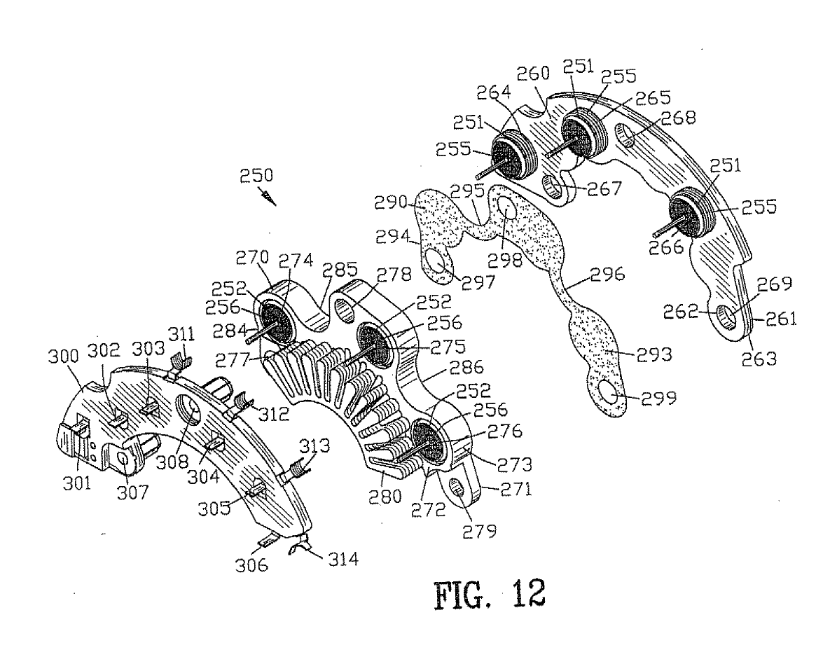

FIG. 12 is an exploded view of the improved rectifier assembly 250 of FIG. 11. The negative heat sink 260 has a first and a second side 261 and 262 and a peripheral edge 263. The negative heat sink 260 defines a plurality of negative diode bores 264-266 and a plurality of mounting holes 267-269 for mounting the negative heat sink 260. Each of the plurality of negative diode bores 264-266 is adapted to receive a negative thermal transfer container 255 housing the negative diode 251.

The positive heat sink 270 has a first and a second side 271 and 272 and a peripheral edge 273. The positive heat sink 270 defines a plurality of positive diode bores 274-276 and a plurality of mounting holes 277-279. The plurality of mounting holes 277-279 of the positive heat sink 270 are aligned with the plurality of mounting holes 267-269 of the negative heat sink 260. Each of the plurality of positive diode bores 274-276 is adapted to receive a positive thermal transfer container 256 housing a positive diode 252.

The positive heat sink 270 includes a supplemental heat sink 280 secured to the second side 272 of the positive heat sink 270 for providing additional cooling for the plurality of positive diodes 252 housed within the plurality of positive thermal transfer containers 256.

The peripheral edge 273 of the positive heat sink 270 is provided with notches 284 -286 for accommodating for the negative thermal transfer containers 255 of the negative heat sink 260.

The insulator 290 defines a peripheral edge 293 having notches 294-296. The notches 294-296 are provided for accommodating for the negative thermal transfer containers 255 of the negative heat sink 260. A plurality of mounting holes 297-299 extending through the insulator 290 for mounting between the negative heat sink 260 and the positive heat sink 270.

The external terminal 300 includes contacts 301, 303 and 305 for connecting to the negative diodes 251 and contacts 302, 304 and 306 for connecting to the positive diodes 252. Plural mounting holes 307 and 308 are aligned with the plural mounting holes 267 and 268 of the negative heat sink 260. The contacts 301-306 are connected to external contacts 311-314.

The rectifier assembly 250 comprises a stacked assembly of the negative heat sink 260, the insulator 290, the positive heat sink 270 and the external terminal 300. The stacked assembly is secured with a mechanical fastener extending through the mounting holes in the negative heat sink 260, the insulator 290, the positive heat sink 270 and the external terminal 300.

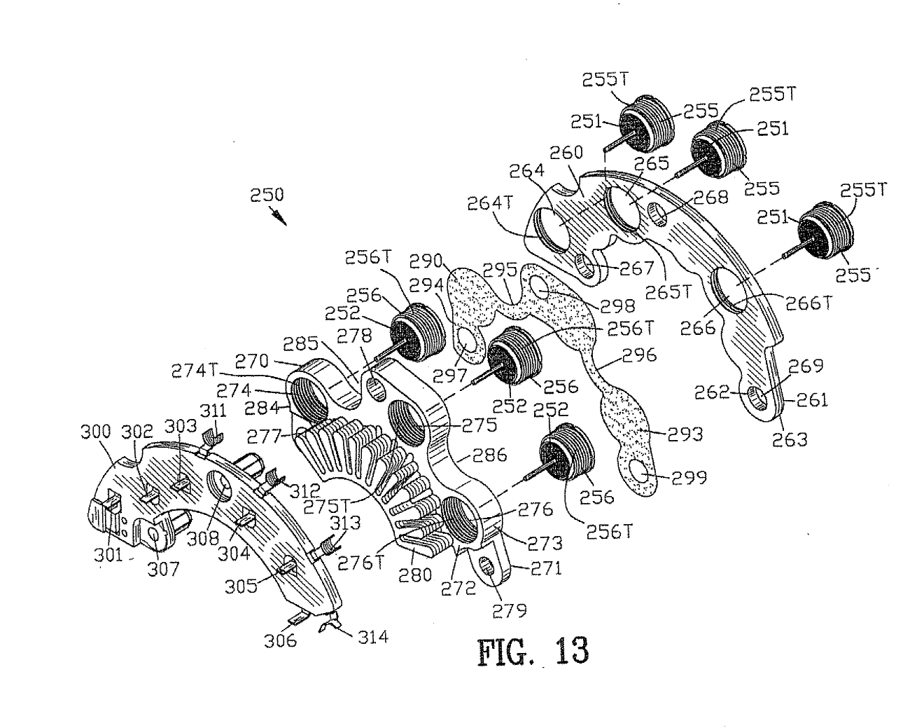

FIG. 13 is an exploded view of the improved rectifier assembly 250 of FIG. 12. Each of the plurality of negative thermal transfer containers 255 includes external threads 255T. Similarly, each of the plurality of negative diode bores 264-266 of the negative heat sink 260 is shown as a threaded bore having threads 264T-266T. In contrast to the prior art shown in FIGS. 1-11, each of the plurality of negative diode bores 264-266 is adapted to receive a negative thermal transfer container 255 housing the negative diode 251 in a threaded engagement.

Each of the plurality of positive thermal transfer containers 256 includes external threads 265T. Similarly, each of the plurality of positive diode bores 274-276 of the positive heat sink 270 is shown as a threaded bore having threads 274T-276T. In contrast to the prior art shown in FIGS. 1-11, each of the plurality of positive diode bores 274-276 is adapted to receive a positive thermal transfer container 256 housing the positive diode 252 in a threaded engagement.

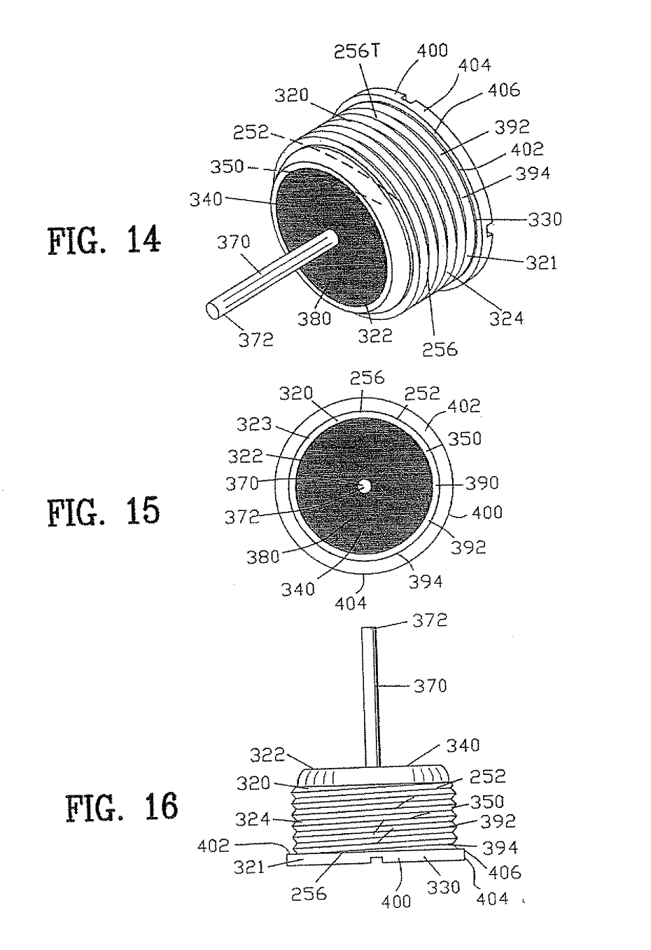

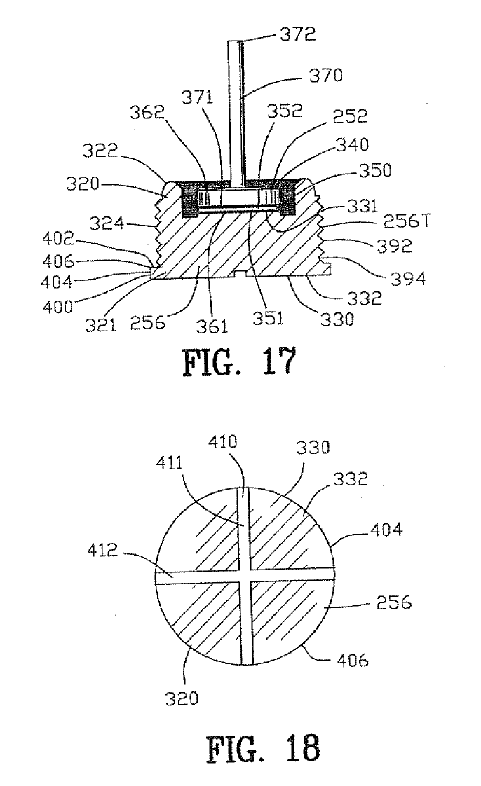

FIGS. 14-18 illustrate various views of thermal transfer container 256 of the present invention for containing the positive diode 252. The thermal transfer container 255 for the negative diode 251 is identical to the thermal transfer container 256 for containing the positive diode 252.

The thermal transfer container 256 is a generally cylindrical container 320 extending between a first and a second cylindrical end 321 and 322 defining an inner cylindrical surface 323 and an outer cylindrical surface 324. Preferably, the thermal transfer container is formed of a metallic material such as aluminum, copper or the like.

A first end wall 330 closes the first end 321 of the cylindrical container 320. The first end wall 330 defines an inner end wall surface 331 and an outer end wall surface 332. The first end wall 330 is integrally formed with the first end 321 of the cylindrical container 320 as a one piece unit. The second end 322 of the cylindrical container 320 defines an opening 340. The generally cylindrical container 320 in combination with the first end wall 330 defines a cup shape having an inner volume 342 for containing the positive diode 252.

The positive diode 252 comprises a wafer 350 having a first and a second terminal 351 and 352. The first terminal 351 is shown as the negative terminal of the semiconductor diode whereas the second terminal 352 is shown as the positive terminal of the positive diode 252. The semiconductor diode is a glass passivated silicon diode.

A first connector 361 connects the first terminal 351 of the positive diode 252 to the inner end wall 331 surface of the first end wall 330 of the cylindrical container 320. The first connector 361 directly connects the positive diode 252 to the first end wall 330 of the cylindrical container 320. Typically, the first connector 361 comprises a first solder connector to provide a simultaneous electrical and thermal connection of the positive diode 252 to the cylindrical container 320.

A second connector 362 comprises an electrical lead 370 extending between a first and a second electrical lead end 371 and 372. The second connector 362 directly electrically affixes the first end 371 of the electrical lead 370 to the second terminal 352 of the positive diode 252. The second end 272 of the electrical lead 270 extends from the opening 340 in the second end 322 of the cylindrical container 320. Typically, the second connector 362 comprises a second solder connector to provide an electrical connection of the first end 371 of the electrical lead 370 to the positive diode 252.

The curable material 380 such as a curable epoxy material or any suitable curable material fills the inner volume 340 of the thermal transfer container 256 for retaining the positive diode 252 within the thermal transfer container 256 and for adding mechanical strength to the electrical lead 370.

As best shown in FIGS. 14, 16 and 17, the outer cylindrical surface 324 of the cylindrical container 320 of the thermal transfer container 256 defines the threads 256T. The threads 256T define thread projections 392 separated by thread voids 394 The threads 256T are integrally formed in the outer cylindrical surface 324 of the cylindrical container 320.

The first end wall 330 extends radially outward from the outer cylindrical sidewall 324 of the cylindrical container 320 to form a radial flange 400. The radial flange 400 extends beyond the outer cylindrical sidewall 324 defining an axial planar surface 402 and a radial cylindrical surface 404 separated by a shoulder 406. The radial flange 400 is integrally formed with the cylindrical container 320 as a one piece unit.

As best shown in FIG. 18, the outer end wall surface 332 of the first end wall 330 of the cylindrical container 320 includes a recess 410 defined in the outer end wall surface 332. The recess 410 defined in the outer end wall surface 332 is adapted to matingly receive a tool (not shown) for rotating the cylindrical container 320 for threadably engaging and disengaging the thermal transfer container 256 from the plurality of positive diode bores 274-276. In this examples the recess 410 is shown as a groove 411 and a cross-groove 412 for matingly receiving a tool such as a Phillips head type screwdriver and the like. Although the recess 410 has been shown as a specific type having a groove 411 and a cross-groove 412, it should be understood that the recess 410 may take any suitable form for threadably engaging and disengaging the thermal transfer container 256 from the plurality of positive diode bores 274-276.

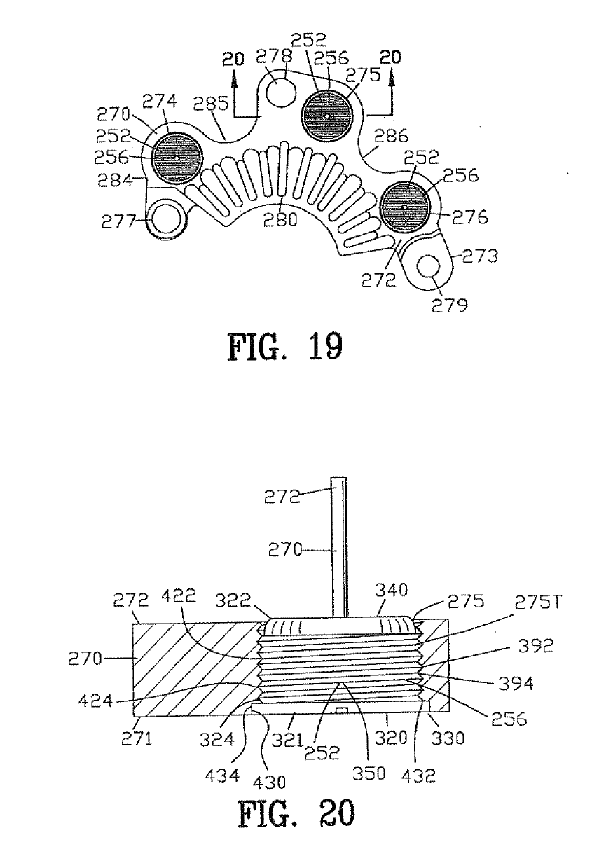

FIG. 19 is a view of the positive thermal transfer container 256 of FIGS. 14-18 secured to the positive heat sink 270. The positive thermal transfer containers 256 are threadably engaged with the positive diode bores 274-276 for providing electrical and thermal connection between the positive thermal transfer containers 256 and the positive heat sink 270.

FIG. 20 is an enlarged view along line 19-19 in FIG. 19 illustrating the positive thermal transfer container 256 threadably engaged with the positive diode bore 275.

The positive diode bore 275 includes the threads 275T formed within the positive diode bore 275. The threads define 275T define thread projections 422 separated by thread voids 424. The threads 275T are integrally formed in the positive heat sink 270.

The positive diode bore 275 includes a counterbore 430 located adjacent to the first side 271 of the positive heat sink 270. The counterbore 430 extends from the first side 271 of the positive heat sink 270 to define an axial planar surface 432 and a radial cylindrical surface 434 separated by a shoulder 436. The counterbore 430 is integrally formed with the positive heat sink 270.

The positive thermal transfer container 256 is threadably engaged with the positive diode bores 275 for providing electrical and thermal connection between the positive thermal transfer containers 256 and the positive heat sink 270. The thread projections 392 and the thread voids 394 of the thermal transfer container 256 cooperate with the thread voids 424 and the thread projections 422 of the positive heat sink 270 for increasing the area of contact between the positive thermal transfer container 256 and the positive heat sink 270. In addition, the axial planar surface 402 of the positive thermal transfer container 256 engages with the axial planar surface 432 of the counterbore 430 for increasing the area of contact between the positive thermal transfer container 256 and the positive heat sink 270. The increaed area of contact between the positive thermal transfer container 256 and the positive heat sink 270 provides an enhanced electrical and thermal conduction between the positive thermal transfer container 256 and the positive heat sink 270.

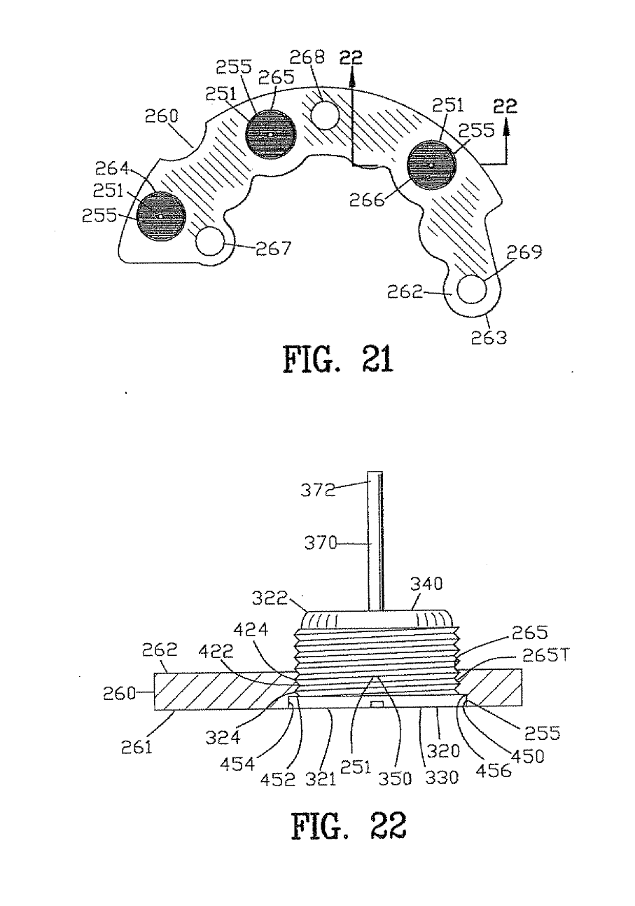

FIG. 21 is a view of the negative thermal transfer container 255 of FIGS. 12 and 13 secured to the negative heat sink 260. The negative thermal transfer containers 255 are threadably engaged with the negative diode bores 264-266 for providing electrical and thermal connection between the negative thermal transfer containers 255 and the negative heat sink 260. The negative thermal transfer containers 255 are identical to the positive thermal container shown in FIGS. 14-20 and incorporates similar reference numerals for similar parts.

FIG. 22 is an enlarged view along line 22-22 in FIG. 21 illustrating the negative thermal transfer container 255 threadably engaged with the negative diode bore 265. The negative diode bore 265 includes the threads 265T formed within the negative diode bore 265. The threads define 265T define thread projections 442 separated by thread voids 444. The threads 265T are integrally formed in the negative heat sink 260.

The negative diode bore 265 includes a counterbore 450 located adjacent to the first side 261 of the negative heat sink 260. The counterbore 450 extends from the first side 261 of the negative heat sink 260 to define an axial planar surface 452 and a radial cylindrical surface 454 separated by a shoulder 456. The counterbore 450 is integrally formed with the negative heat sink 260.

The negative thermal transfer container 255 is threadably engaged with the negative diode bores 265 for providing electrical and thermal connection between the negative thermal transfer containers 255 and the negative heat sink 260. The thread projections 392 and the thread voids 394 of the negative thermal transfer container 255 cooperate with the thread voids 444 and the thread projections 442 of the negative heat sink 260 for increasing the area of contact between the negative thermal transfer container 255 and the negative heat sink 260. In addition, the axial planar surface 402 of the negative thermal transfer container 255 engages with the axial planar surface 452 of the counterbore 450 for increasing the area of contact between the negative thermal transfer container 255 and the negative heat sink 260+The increased area of contact between the negative thermal transfer container 255 and the negative heat sink 260 provides an enhanced electrical and thermal conduction between the negative thermal transfer container 255 and the negative heat sink 260. A heat rise test comparison between the diode rectifier of the present invention and press fit diode rectifier is shown in Table 1 below.

TABLE 1
HEAT RISE TEST

| | SCREW DIODE | | | | | PRESS FIT DIODE | | | | |
|---|---|---|---|---|---|---|---|---|---|---|
| | RECTIFIER | | | | | RECTIFIER | | | | |
| | DR4000 (ND) | | | | | Transpo DR4000 | | | | |
| | Temperature (deg C.) | | | | | Temperature (deg C.) | | | | |
| | Positive | POS | Negative | NEG | | Positive | POS | Negative | NEG | |
| Time | HS | HS | HS | HS | Output | HS | HS | HS | HS | Output |
| (mins) | diode | Wire #2 | diode | Wire #2 | Current | diode | Wire #2 | diode | Wire #2 | Current |
| 0 | 26.0 | 26.0 | 25.6 | 23.5 | 97 | 24.0 | 24.0 | 24.0 | 24.0 | 97 |
| 1 | 91.0 | 81.0 | 67.8 | 44.9 | | 84.0 | 73.0 | 73.0 | 67.0 | |
| 2 | 105.0 | 98.0 | 73.2 | 52.1 | | 107.0 | 98.0 | 72.0 | 81.0 | |
| 3 | 111.0 | 105.0 | 74.7 | 70.0 | | 115.0 | 108.0 | 80.8 | 83.4 | |
| 4 | 114.0 | 108.0 | 75.6 | 75.1 | | 119.0 | 111.0 | 87.1 | 92.6 | |
| 5 | 115.0 | 109.0 | 74.7 | 77.9 | 97 | 121.0 | 113.0 | 90.3 | 95.3 | 97 |
| 6 | 116.0 | 110.0 | 76.3 | 79.3 | | 122.0 | 114.0 | 92.6 | 95.7 | |
| 7 | 116.0 | 111.0 | 76.0 | 80.2 | | 122.0 | 115.0 | 93.7 | 97.4 | |
| 8 | 117.0 | 112.0 | 76.2 | 80.4 | | 122.0 | 115.0 | 95.0 | 98.5 | |
| 9 | 117.0 | 112.0 | 76.4 | 80.4 | | 122.0 | 116.0 | 95.5 | 98.8 | |
| 10 | 117.0 | 112.0 | 76.9 | 80.2 | 93 | 122.0 | 116.0 | 96.0 | 99.1 | 94 |
| 11 | 117.0 | 112.0 | 77.0 | 80.1 | | 123.0 | 116.0 | 96.3 | 99.3 | |
| 12 | 117.0 | 112.0 | 77.1 | 79.9 | | 123.0 | 116.0 | 96.5 | 99.4 | |
| 13 | 117.0 | 112.0 | 77.2 | 79.6 | | 123.0 | 116.0 | 96.8 | 99.6 | |
| 14 | 117.0 | 112.0 | 77.4 | 79.4 | | 123.0 | 116.0 | 97.0 | 99.8 | |
| 15 | 117.0 | 113.0 | 77.8 | 79.1 | 92 | 123.0 | 116.0 | 97.0 | 99.8 | 92 |
| 16 | 117.0 | 113.0 | 77.1 | 78.8 | | 123.0 | 117.0 | 97.3 | 99.9 | |
| 17 | 117.0 | 113.0 | 77.8 | 78.7 | | 123.0 | 117.0 | 97.3 | 100.0 | |
| 18 | 117.0 | 112.0 | 77.6 | 78.6 | | 123.0 | 117.0 | 97.5 | 100.1 | |
| 19 | 117.0 | 113.0 | 77.9 | 78.3 | | 123.0 | 117.0 | 97.6 | 100.1 | |
| 20 | 118.0 | 113.0 | 78.0 | 78.1 | 91 | 123.0 | 117.0 | 97.6 | 100.2 | 91 |
| 21 | 117.0 | 113.0 | 77.9 | 77.9 | | 122.0 | 117.0 | 97.8 | 100.2 | |
| 22 | 118.0 | 114.0 | 78.2 | 77.6 | | 122.0 | 117.0 | 97.9 | 100.4 | |
| 23 | 118.0 | 114.0 | 78.0 | 77.4 | | 123.0 | 118.0 | 98.0 | 100.4 | |
| 24 | 118.0 | 113.0 | 77.9 | 77.2 | | 123.0 | 118.0 | 98.2 | 100.4 | |
| 25 | 118.0 | 114.0 | 78.5 | 77.1 | 91 | 123.0 | 118.0 | 98.3 | 100.6 | 91 |
| 26 | 118.0 | 113.0 | 78.5 | 76.9 | | 123.0 | 118.0 | 98.4 | 100.7 | |
| 27 | 118.0 | 114.0 | 78.2 | 76.6 | | 123.0 | 118.0 | 98.3 | 100.7 | |
| 28 | 118.0 | 114.0 | 78.7 | 76.5 | | 123.0 | 118.0 | 98.4 | 100.7 | |
| 29 | 119.0 | 114.0 | 78.5 | 76.4 | | 123.0 | 118.0 | 98.5 | 100.9 | |
| 30 | 119.0 | 114.0 | 79.0 | 76.3 | 91 | 123.0 | 119.0 | 98.9 | 101.0 | 91 |

| | |
|---|---|
| Date of Test 37715.0 Room Temp 23.1 deg C. | Date of Test 37715.0 Room Temp 23.2 deg C. |

POS HS Wire #1 and POS HS Wire #2 used Fluke 77 DMM ID no. 4736 and Thermocouple Module ID no. 5478
NEG HS Wire #1 and NEG HS Wire #2 used Fluke 87III DMM ID no. 3849 and Thermocouple Module ID no. 547
Alternator Output 160 A
Alternator Speed 3000 rpm

The thermal transfer container of the present invention provides a solution for many of the disadvantages of the prior art.

The threaded engagement between the thermal transfer container and the heat sink reduces the unreliable electrical and thermal connection produced by the variation in the outer diameter of the knurl projections and/or variation in the inner diameter of the diode bore of the prior art. The thread projections and the thread voids of the thermal transfer container cooperate with the thread voids and the thread projections of the heat sink for increasing the area of contact between the thermal transfer container and the heat sink, compensating for variation in the thread projections and/or thread voids in the thermal transfer container and/or heat sink.

The threaded engagement between the thread projections and the thread voids of the thermal transfer container with the thread voids and the thread projections of the heat sink of the present invention provides an enhanced electrical and thermal conductivity between the thermal transfer container and a heat sink relative to the prior art.

The engagement between the axial planar surface of the thermal transfer container engages with the axial planar surface of the counterbore enhancing the electrical and thermal conduction between the thermal transfer container and the heat sink.

The thermal transfer container is not deformed when the thermal transfer container is threadably engaged with the heat sink thus eliminating any possibility of damaging the diode within the cylindrical container.

The threaded engagement between the thermal transfer container and the heat sink enables the diode to be replaced in the event of failure during operation without the replacement of the entire rectifier assembly.

The present invention has been described with reference to use within a rectifier assembly for an alternator. It should be understood that the present disclosure is by way of example, and that the present invention may be incorporates into any application requiring the enhanced electrical and/or thermal transfer of heat to a heat sink.

Although the invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1-27. (canceled)

28. A rectifier assembly comprising:
negative and positive heat sink plates spaced from each other, each having threaded diode receiving orifices;
positive and negative diode assemblies threaded into the respective threaded orifices of positive and negative heat sink plates; and
an insulator separating the respective negative and positive heat sink plates.

29. A rectifier assembly according to claim 28, wherein each diode assembly comprises a cylindrical container and semiconductor diode received therein, and threads formed on the cylindrical container.
